(19) United States
(12) Patent Application Publication
(10) Pub. No.: US 2004/0006677 A1
(43) Pub. Date: Jan. 8, 2004

(54) Microcomputer and method for controlling a microcomputer

(75) Inventors: Hirotomo Kobayashi, Tokyo (JP); Yoshiaki Tominaga, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/397,307

(22) Filed: Mar. 27, 2003

(30) Foreign Application Priority Data
Mar. 27, 2002 (JP) P2002-90030

(51) Int. Cl. G06F 12/00

(52) U.S. Cl. 711/173; 711/154

(57) ABSTRACT

A method for processing a microcomputer having a central processing unit detects an interrupt process. The method disrupts a first task under an execution. Then, the method determines the interrupt process and assigns a second task for the interrupt process. The method sets up a second bank for the second task and executes the second task at the second bank. Further more, the method resumes the first task after executing the second task.

### CROSS REFERENCE TO RELATED APPLICATIONS

This application is based upon and claims the benefit of priority from prior Japanese Patent Application P2002-090030 filed on March 27, 0.2002; the entire contents of which are incorporated by reference herein.

### BACKGROUND OF THE INVENTION

1. Field of the Invention

The present invention relates to a microcomputer and method for controlling a microcomputer having a function to perform task scheduling and context changing on hardware.

2. Description of the Related Art

A micro processing unit (MPU) generally has a central processing unit (CPU), having a plural number of registers, and a memory management unit (MMU). The MMU is a hardware performing memory management for protecting and mapping of a memory. By using the MMU, a logical address space such as application software and a physical memory may be treated and address switching separately. Generally, the MMU divides the physical memory (or a physical space) into each block to manage. The “block” may be called a “page” or a “segment” and the block is assigned to a logical space (or a virtual space). By using this function, the MMU may provide a virtual memory (or a virtual space), which is larger than a physical memory (or a physical space), to software programs. In addition, the MMU may also increase a security level by executing each of the application programs and an operation system (OS) in different logical addresses.

A microcomputer or a MMU generally has a virtual space (or a virtual memory) and a memory (a physical space) which exists in an actual memory device. Then, a CPU corresponds the physical space (or the physical memory) to the virtual space (or the virtual memory). Then, a corresponding range of the space managed by the MMU is called a “bank.” Since a former MPU had only one MMU, the former MPU had only one bank.

As it has been explained, when a plural number of programs or application programs are concurrently executed in a former microcomputer, functions, such as a task-switching and a scheduling, must be processed by a software program (or an operating system (OS)) since the microcomputer has a plural number of CPU registers but has only one MMU.

In the past, when an interrupt handling is processed on the microcomputer, many processes were performed before a disrupted task returns from interrupt. In other words, since the microcomputer has only one MMU, the physical space is corresponded to the virtual space every time each of essential tasks is replaced when the task switching has occurred. For example, when the process of the task is disrupted and an interrupt is determined, next interrupt handling may not be processed instantly. Thus, first, a register is stored in a stuck (or the virtual space) to enable the interrupt in order to proceed to the interrupt handling. In addition, when the interrupt service routine is started and the routine is finished, the disrupted task may not instantly recover from the disruption. In order to do so, first, the register is recovered from the stuck and the interruption is disabled. Then, the disrupted task returns from interrupt.

When the microcomputer has only one MMU, there is a problem that a tremendous amount of wasting time (or overhead time) is needed when the context switching is performed. Especially for the interrupt handling, which is frequently executed, the overhead time becomes a big problem. In addition, reducing an overhead time of an interrupt handling, such as a use of an external input-output unit, is a major issue for development of the operating system.

### SUMMARY OF THE INVENTION

A microcomputer includes a central processing unit configured to have a plural number of registers and a plural number of memory management units corresponding to each of the registers.

A microcomputer includes a privileged bank configured to correspond to a certain memory management unit set up for executing at reset, start and bank switching.

A method for processing a microcomputer having a central processing unit includes: detecting an interrupt process; disrupting a first task under an execution; determining the interrupt process and assigning a second task for the interrupt process; setting up a second bank for the second task; executing the second task at the second bank; and resuming the first task after executing the second task.

A method for processing a micro computer having a central processing unit includes executing a privilege bank corresponding to a certain memory management unit set up for executing at reset, start and bank switching.

### BRIEF DESCRIPTION OF DRAWINGS

FIG. 1 illustrates a block diagram of the microcomputer of the present invention.

FIG. 2 illustrates a conceptual diagram of the microcomputer shown in FIG. 1.

FIG. 3A illustrates a memory 9 shown in FIG. 1.

FIG. 3B illustrates an exemplary flow of the microcomputer shown in FIG. 1.

FIG. 4 illustrates the microcomputer of the present invention when the method 3 is in process.

FIG. 5 illustrates a flow diagram of the method for controlling the microcomputer of the present invention.

### DETAILED DESCRIPTION OF EMBODIMENT

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details in other instances, well-known circuits have been shown in block diagram form in order not to obscure the present invention in unnecessary detail.

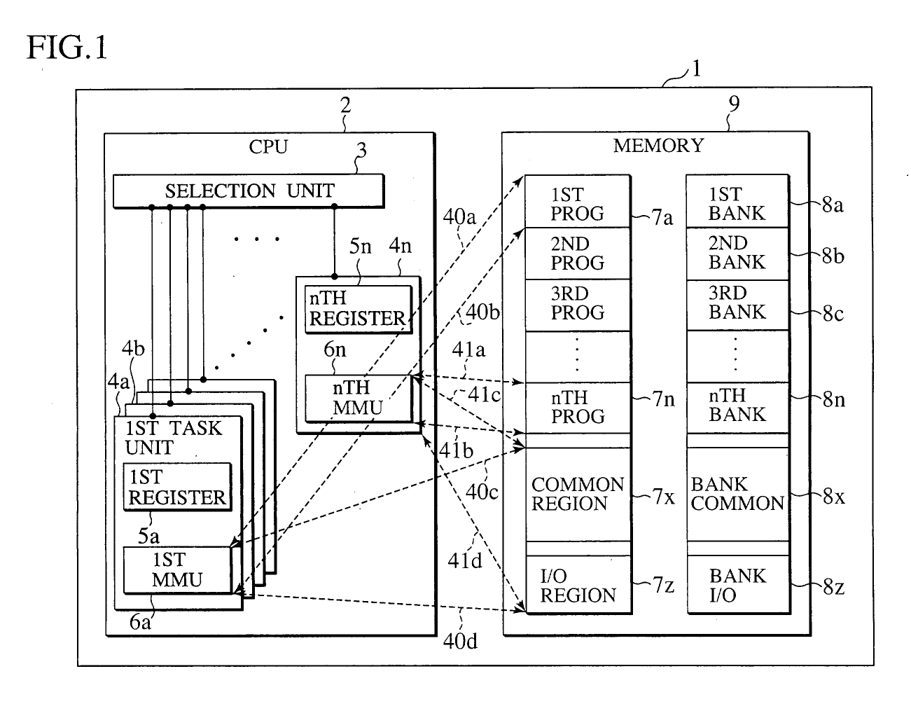

As shown in FIG. 1, a microcomputer 1 of the present invention includes a central processing unit (CPU) 2 and a memory (or a physical space) 9. The CPU 2 includes a first task unit 4a having a set of a first register 5a and a first memory management unit (MMU) 6a, a second task unit 4b having a set of a second register 5b and a second MMU 6b, a nth task unit 4n having a set of a nth register 5n and a nth MMU 6n, and a selection unit 3 connected to the first through nth task unit 4a-4n. The memory 9 includes a first program 7a, a nth program 7n, a common region 7x, an input/output (I/O) region 7z, a first bank 8a, a second bank 8b, a third bank 8c, a nth bank 8n, a bank common 8x and a bank input/output (I/O) 8z.

The first MMU 6a is corresponding to the first program 7a, the common region 7x and the I/O region 7z in the memory 9. A management region of the first through nth MMU 6a-6n is shown as corresponding regions, called “bank.” Since the microcomputer 1 of the present invention includes a plural number of MMU (such as the first through the nth MMU 6a-6n) the management region of the MMU is corresponded to a plural number of banks (such as the first through the nth bank 8a-8n, the bank common 8x and the bank I/O) in the memory 9, a physical space. Broken lines 40a and 40b, broken lines 41a and 41b show a memory region of the memory 9 which each of the first MMU 6a and the nth MMU 6n manages. For instance, the first MMU 6a manages the memory region where-the first program 7a is stored, and the nth MMU 6n manages the memory region where the nth program 7n is stored. In addition, as a broken line 40c, a broken line 40d, a broken line 41c and a broken line 41d illustrate, each of the first MMU 6a and the nth MMU 6n accesses to the common region 7x and the I/O region 7z.

As it is explained, by using the microcomputer of the present invention, a task switching and a task scheduling may be processed on hardware since the microcomputer handles a set of a register and a MMU as a task within the CPU 2. Therefore, the microcomputer of the present invention reduces the overhead time and solves other problems when the task switching and the task scheduling are processed on the software. In addition, by having a common memory (or the common region 7x) and an input/output memory (the I/O region 7z), the microcomputer of the present invention may create an inter-task communication program within the hardware to perform the same function as an operating system (OS) provides.

The selection unit 3 of the present invention switches task units quickly based on an instruction or an exception, including an interrupt, from the application programs. The instruction from the application program may include information of a new task unit switched from an old task unit, or may include a simple instruction to do switching task units. When the instruction from the application program includes the simple instruction to do switching, the new task unit switched from the old task unit should be set up at the selection unit 3 before receiving the instruction from the application program.

For example, when the CPU 2 receives the instruction to switch to the (n−2)th application program 9n while the first application program 9a is executed, the instruction 20b includes information for switching to the (n−2)th bank 8j of the (n−2)th application program 9n. The instruction 20b is interpreted by the CPU 2 and the CPU 2 sends an instruction to the selection unit 3 to switch the certain task units. When the selection unit 3 switches the task units, corresponding bank and application program are switched at the same time. Thus, the selection unit 3 switches the first task unit 4a to an (n−2)th task unit, the first bank 8a and the first application program 9a are also switched to the (n−2)th bank 8j and the (n−2)th application program 9n.

For another example, when the CPU 2 receives the instruction to switch to the (n−2)th application program 9n based on the interrupt signal while the first application program 9a is executed, the CPU 2 or the selection unit 3 interprets the interrupt signal. When the CPU 2 or the selection unit 3 interprets the interrupt signal, the task units are switched and corresponding bank and application program are also switched.

Although the microcomputer 1 of the present invention includes the CPU 2 and the memory 9 as shown in FIG. 1, the memory 9 may be connected as an external memory unit configured to be connected to the microcomputer 1 or the CPU 2. The selection unit 3 of the present invention may be included in the CPU 2 or connected to the CPU 2 as an external unit. The selection unit 3

Method 1

First, a method for controlling the microcomputer 1 of the present invention will be explained as a “method 1” of the present invention.

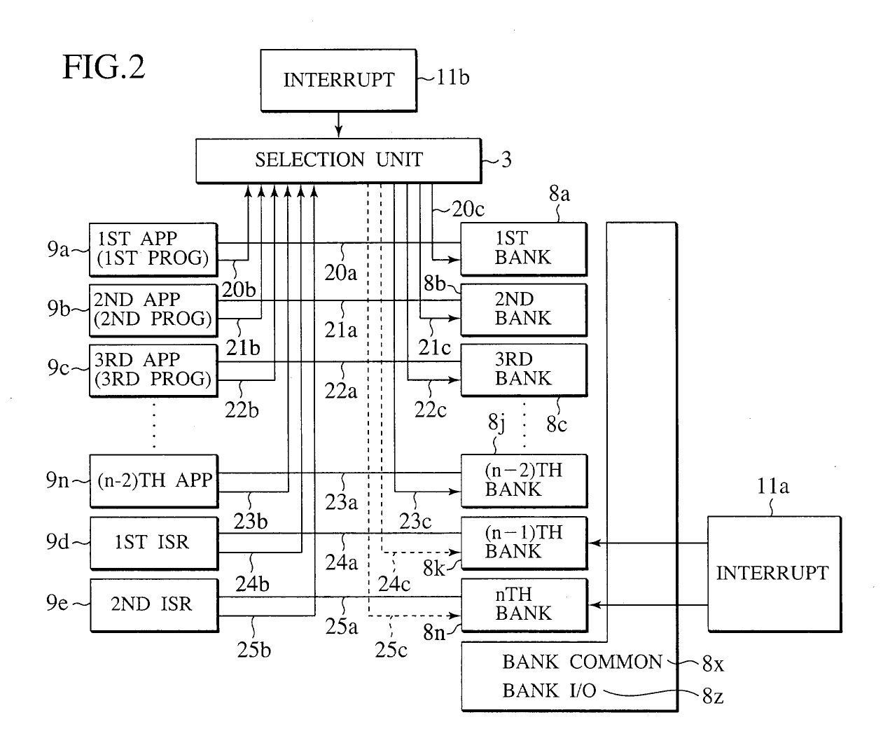

As shown in FIG. 2, each of a first application program 9a through the (n−2)th application program 9n, a first interrupt service routine (ISR) 9d and a second ISR 9e corresponds to each of the first program 7a through the nth program 7n, which are concurrently executed as the first task unit 4a through the nth task unit 4n shown in FIG. 1. In addition, an instruction 20b, an instruction 21b, an instruction 22b, an instruction 23b, an instruction 24b and an instruction 25b, input to the selection unit 3, are instructions to enable and disable the tasks, such as the first through the nth task units 4a-4n. Further more, the first through the nth banks 8a-8n are bank regions correspond to the first thorough the nth programs 7a-7n.

The microcomputer, having the structure explained above, inputs one of the instructions 20c, 21c, 22c, 23c, 24c or 25c, corresponding to an objected task, into the selection unit 3 when the microcomputer of the present invention disables a certain task. Then, the selection unit 3 executes the objected instruction to a corresponding bank to disable the interrupt.

For instance, the first task unit 4a is a task to disable the first application program 9a. In order to disable the first application program 9a, first, the CPU 2 executes the task 4a to start the process. When the task 4a is executed by the CPU 2, the first MMU 6a accesses and executes the first program 7a. Since the first program 7a is corresponding to the first application program 9a, the first application program 9a is executed when the first program 7a is executed. When the first application program 9a is executed, the first application program 9a sends the instruction 20b to the selection unit 3 and the selection unit 3 sends the instruction 20c to the first bank 8a to disable.

Controlling enable and disable of the tasks may be done by special instructions or by masking a control bit by software. The method 1 or the method for controlling the microcomputer of the present invention may control tasks in a high speed with very easy operations.

Method 2

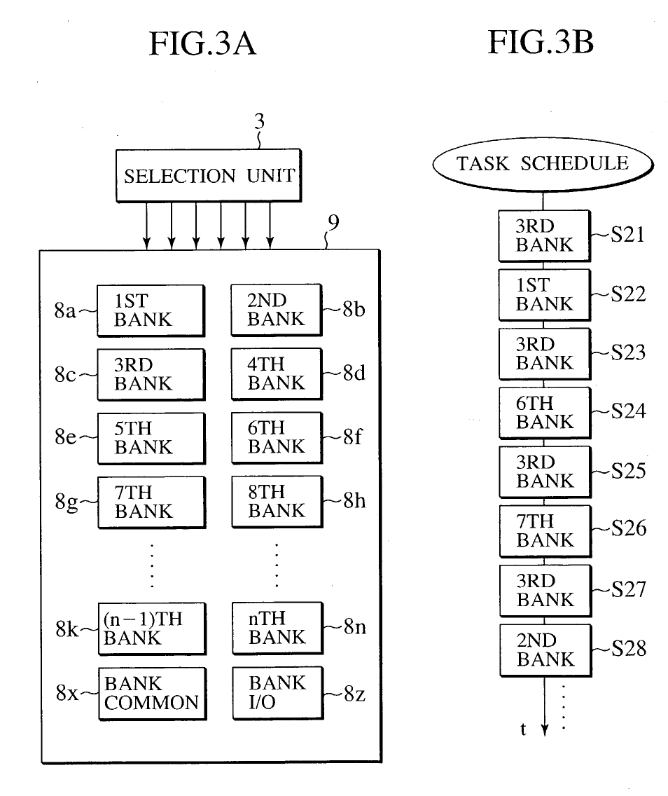

As shown in FIG. 3A and FIG. 3B, the method for controlling the microcomputer of the present invention will be explained as a “method 2” of the present invention. In the method 2, a method for setting up a process to proceed to a certain MMU bank (or a privileged bank) when one of a reset process, a starting process or a bank switching process is executed. As shown in FIG. 3A, memory 9 has a plural number of bank regions, such as a first bank 8a, a second bank 8b, a third bank 8c, a fourth bank 8d, a fifth bank 8e, a seventh bank 8f, a (n−1)th bank 8k, a nth bank 8n, a bank common 8x and a bank I/O 8z.

In the method 2 of the present invention, the third bank 8c is set up as a certain MMU bank or a privileged bank, having a special instruction or a bit mask. Therefore, the third bank 8c is executed at reset, start and bank switching. In other words, the third bank 8c is executed between executions of other banks for communications between the tasks, reading and tracing contents of a common memory.

FIG. 3B shows a task schedule of the method 2 of the present invention. In step S21, the third bank 8c is executed as a stating process. Then, in step S22, the first bank 8a is executed. In order to switch task, the third bank 8c is executed to read the common memory so that the first bank 8a may communicate with the next bank, which is the sixth bank 8f. In step S24, the sixth bank 8f is executed. At this time, the sixth bank 8f traces the contents of the common memory to share the contents with the first bank 8a. In step S25, the third bank 8c is executed to read the common memory so that the sixth bank 8f may communicate with the next bank, the seventh bank 8g. In step S26, the seventh bank 8g is executed and the seventh bank 8g traces the contents of the common memory to share the contents with the sixth bank 8f. In step S27, the third bank 8c is executed again to read the common memory so that the seventh bank 8g may communicate with the next bank, the second bank 8b. In step S28, the second bank 8b is executed and the second bank 8b traces the contents of the common memory to share the contents with the seventh bank 8g, and so on.

Between executing the tasks, the third bank 3c is executed to read and trace the common memory. Therefore, the tasks may share the contents with the other tasks on the process. By using the microcomputer and the method for controlling the microcomputer of the present invention, processes such as debugging may be done easily and fast.

Method 3

As a “method 3,” a method for specifying a range of each bank with in the memory corresponding to each task will be explained. In the method 3, there are 4 tasks in the CPU 2, and each task has a corresponding bank, which is specified by a user. Since an objected program to execute has a different size for each time, the user is able to specify a range (or size) of the corresponding bank by executing a MMU management address instruction (or an address instruction).

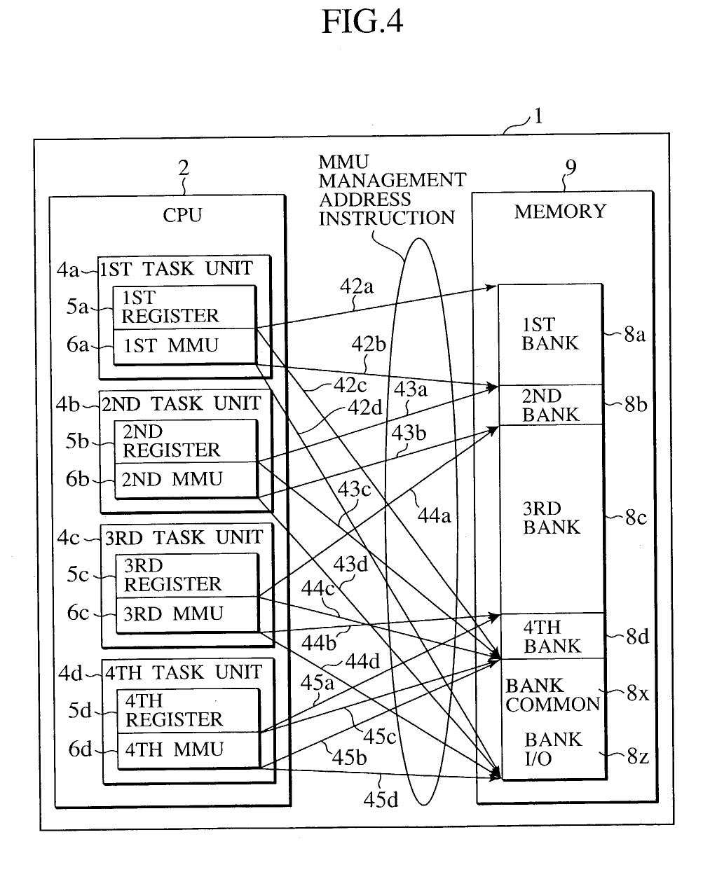

As shown in FIG. 4, the microcomputer 1 has the CPU 2 and the memory 9. The CPU 2 has the first task unit 4a having the first register 5a and the first MMU 6a, the second task unit 4b having the second register 5b and the second MMU 6b, the third task unit 4c having the third register 5c and the third MMU 6c, and the fourth task unit 4d having the fourth register 5d and fourth MMU 6d. The memory 9 has the first bank 8a, the second bank 8b, the third bank 8c, the fourth bank 8d, the bank common 8x and the bank I/O 8z, and ranges or sizes of the banks may be specified by the MMU management address instructions specified by the user.

The first MMU 6a manages the first bank 8a, the second MMU 6b manages the second bank 8b, the third MMU 6c manages the third bank 8c, and the fourth MMU 6d manages the fourth bank 8d. The bank common 8x and the bank I/O 8z are shared by the first through the fourth MMU 6a-6d.

The first MMU 6a sets up a size of the first bank 8a by sending the address instructions 42a and 42b. The second MMU 6b sets up a size of the second bank 8b by sending the address instructions 43a and 43b. The third MMU 6c sets up a size of the third bank 8c by sending the address instructions 44a and 44b. The fourth MMU 6d sets up a size of the fourth bank 8d by sending the address instructions 45a and 45b.

Since the sizes and ranges of the each bank within the memory may be specified, the microcomputer and the method for controlling the microcomputer of the present invention may use the memory, which has a limited capacity, in more effective ways.

Method 4

A method 4 shows a method for processing an interrupt during processing the first task unit 4a (TASK A) on the microcomputer 1 of the present invention shown in FIG. 1.

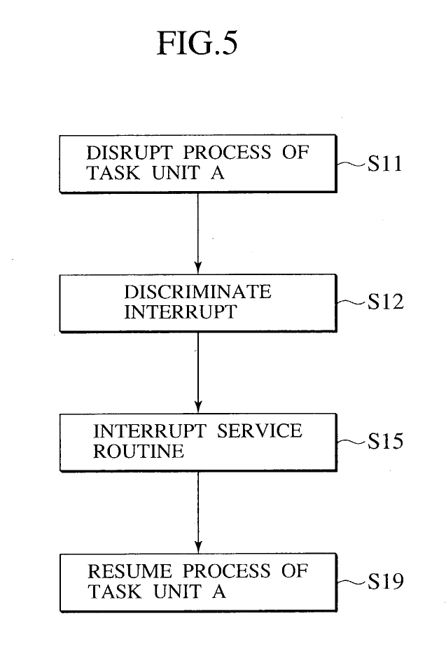

During the first task unit 4a, shown in FIG. 1, is under the process on the microcomputer 1 of the present invention, the interrupt process comes into the microcomputer 1. As shown in FIG. 5, in step S11, the CPU2 disrupts the process of the first task unit 4a.

Then, in step S12, the selection unit 3 determines the interrupt and assigns the second task unit 4b (TASK B) as an interrupt process. The second MMU 6b of the second task unit 4b assigns the second bank 8b in the memory 9.

Instep S15, the second MMU 6b executes an interrupt service routine on the second bank 8b. When the interrupt service routine is ended, the first MMU 6a resumes the process of the first task unit 4a in step S19.

The microcomputer and the method for controlling the microcomputer of the present invention may provide simple and fast processes for controlling the microcomputer.

### Other Embodiment

Although the embodiment of the present invention has been described in detail, the invention may be embodied in other specific forms without departing from the spirit or essential characteristics thereof.

The function of the microcomputer and the method for controlling the microcomputer of the present invention may be programmed and saved in a computer-readable recording medium. For the method for controlling the microcomputer of the present invention, the programs saved in the recording medium is transferred to a memory in a computer system and then operated by its operating unit, thus putting the method in practice. The recording medium may be selected from semiconductor memories, magnetic disks, optical disks, optomagnetic disks, magnetic tapes, and any of the computer-readable recording mediums.

The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A microcomputer comprising a central processing unit configured to have a plural number of registers and a plural number of memory management units corresponding to each of the registers.

2. The microcomputer of claim 1 further comprising a plural number of tasks configured to have a register and a memory management unit corresponding to the register.

3. The microcomputer of claim 2 further comprising a memory configured to have a plural number of regions corresponding to each of the memory management units, a common region and an input-output region commonly accessed by each of the memory management units.

4. The microcomputer of claim 3 wherein the memory comprises a region configured to a user to set up.

5. The microcomputer of claim 4, wherein the region is a memory management unit bank for an interrupt process within the memory.

6. A microcomputer comprising a privileged bank configured to correspond to a certain memory management unit set up for executing at reset, start and bank switching.

7. A method for processing a microcomputer having a central processing unit comprising:
detecting an interrupt process;
disrupting a first task under an execution;
determining the interrupt process and assigning a second task for the interrupt process;
setting up a second bank for the second task;
executing the second task at the second bank; and
resuming the first task after executing the second task.

8. A method for processing a micro computer having a central processing unit comprising executing a privilege bank corresponding to a certain memory management unit set up for executing at reset, start and bank switching.

9. The method of claim 8 wherein the microcomputer concurrently processes a first bank and a second bank, and the first bank and the second bank shares contents of a common bank, the method further comprising:
executing a process of the first bank;
executing a process of the special bank after the process of the first bank and before a process of the second bank; and
reading the common bank during the process of the special bank.

10. A computer program for use with a microcomputer, the computer program comprising:
instructions configured to detect an interrupt process;
instructions configured to disrupt a first task under an execution;
instructions configured to determine the interrupt process and assign a second task for the interrupt process;
instructions configured to set up a second bank for the second task;
instructions configured to execute the second task at the second bank; and
instructions configured to resume the first task after executing the second task.

11. A computer program for use with a microcomputer, the computer program comprising instructions configured to execute a privilege bank corresponding to a certain memory management unit set up for executing at reset, start and bank switching.

12. The computer program of claim 11 wherein the microcomputer concurrently processes a first bank and a second bank, and the first bank and the second bank shares contents of a common bank, the computer program further comprising:
instructions configured to execute a process of the first bank;
instructions configured to execute a process of the special bank after the process of the first bank and before a process of the second bank; and
instructions configured to read the common bank during the process of the special bank.
